(19) United States
(12) Patent Application Publication
(10) Pub. No.: US 2006/0258760 A1
(43) Pub. Date: Nov. 16, 2006

(54) Rubber composition for use in a power transmission belt and power transmission belt made using the rubber composition

(75) Inventors: Takayuki Utsumi, Himeji (JP); Takeshi Nishiyama, Kakogawa (JP)

Correspondence Address: WOOD, PHILLIPS, KATZ, CLARK & MORTIMER, 500 W. MADISON STREET, SUITE 3800, CHICAGO, IL, 60661, US

(73) Assignee: Mitsuboshi Belting Ltd.

(21) Appl. No.: 11/375,715

(22) Filed: Mar. 15, 2006

(30) Foreign Application Priority Data
Mar. 16, 2005 (JP) 74182/2005
Nov. 29, 2005 (JP) 344483/2005
Feb. 23, 2006 (JP) 46767/2006

(51) Int. Cl. C08J 11/04

(52) U.S. Cl. 521/41

(57) ABSTRACT

A power transmission belt having an endless body with a length, an inside, an outside, and laterally spaced sides. At least a part of the belt body is made from a rubber composition, including a fresh rubber, a powdery scrap rubber, and a recycled rubber. The powdery scrap rubber and recycled rubber collectively make up a substantial portion of the rubber composition.

### BACKGROUND OF THE INVENTION

1. Field of the Invention

This invention relates to rubber compositions that can be used in power transmission belts and, more particularly, to a rubber composition made using recycled industrial waste products such as those generated during the production of power transmission belts.

2. Background Art

It is common to make raw edge V-belts as follows. A canvas layer is wrapped around a cylindrical molding drum. Thereafter, a composite component, consisting of a compression rubber layer and cushion rubber layer, is wrapped over the canvas layer. A load carrying member is spirally wrapped around the composite component, followed by another cushion rubber layer and an additional canvas layer. The resulting sleeve structure is then vulcanized and thereafter cut into “V” shapes with a predetermined width, as by a pair of spaced, rotary cutters. Each belt is then trained around a pair of spaced pulleys and advanced in a manner that the side surfaces of the belt can be sanded to effect polishing thereof. Such a process is disclosed, for example, in Japanese Patent No. 3,553,371.

In another known method, V-ribbed belts are produced as follows. A canvas layer is wrapped around a cylindrical molding drum. A cushion rubber layer is wrapped over the canvas layer. A load carrying member is spirally wrapped around the cushion rubber layer, after which another cushion rubber layer is applied, followed by a compression rubber layer. The resulting sleeve is vulcanized. The molding drum with the vulcanized sleeve thereon is rotated and ground by slowly lowering a grinding stone with a V-shaped groove rotating at a high speed, thereby producing individual belt grooves. The sleeve is then cut to a desired width while the sleeve is rotated to produce individual V-ribbed belts.

With the above methods, it is common to sever individual belt preforms from the sleeve, each with a trapezoidal shape. Thereafter, additional processing of the belt side surfaces is required, which may be accomplished by sanding or grinding. As an alternative to the processes described above, the side surfaces of the belt may be finish-processed by grinding edges.

In any event, a significant amount of scrap, such as ring-shaped, removed pieces, grinding dust, and polishing dust are generated during these processes. Ideally, the amount of scrap generated is minimized.

It is known to either place the scrap in land fills as industrial waste or to use the same as a fuel. Placement in a land fill is not desired from the standpoint that ground and/or water supplies may become polluted.

In the event that the scrap is used as fuel, carbon dioxide is generated that contributes to the problem of environmental warming. It is common to construct belts with a compression rubber layer made from a rubber composition including chloroprene rubber. Scraps containing chloroprene rubber tend to generate toxic gas and may pollute the environment and cause premature deterioration of furnaces in which the waste product is burned.

In view of the above problems, it is known to recycle products that are otherwise disposed of as waste in the formation of power transmission belts. For example, as disclosed in Japanese Patent No. 3,212,928, it is known to add recycled material, such as recycled rubber generated during belt production, powdered rubber produced by crushing belt waste, or rubber dust produced different portions of belts are ground during the formation thereof.

However, it has been found that when a large amount of the recycled rubber is added to a composition, the resulting belt may have a reduced elasticity modulus and a detrimentally shortened life as compared to similarly constructed belt using non-recycled products. In the event that a large amount of powdery rubber is added to the composition, the unvulcanized rubber generally will have increased viscosity and reduced tackiness, as a result of which the material does not have good workability during the belt formation process. Consequently, the amount of recycled rubber and powdery rubber have been used in very limited quantities, as a result of which a significant amount of generated waste may not be practically recyclable.

### SUMMARY OF THE INVENTION

In one form, the invention is directed to a power transmission belt having an endless body with a length, an inside, an outside, and laterally spaced sides. At least a part of the belt body is made from a rubber composition, including a fresh rubber, a powdery scrap rubber, and a recycled rubber. The powdery scrap rubber and recycled rubber collectively make up a substantial portion of the rubber composition.

The combined total amount of the powdery scrap rubber and the recycled rubber may be from 30 to 1 10 parts by weight per 100 parts by weight of the fresh rubber.

The weight ratio of the recycled rubber to the powdery scrap rubber may be 0.4 to 2.5.

In one form, the fresh rubber includes chloroprene rubber.

The powdery scrap rubber may have an average primary particle diameter of 30 to 500 μm.

In one form, the belt body has a compression rubber layer and the compression rubber layer is made up of at least the rubber composition.

The belt body may include at least one load carrying member extending in a lengthwise direction.

The power transmission belt may be one of a V-belt and a V-ribbed belt.

In one form, there is at least one canvas layer on at least one of the inside and outside of the belt body.

The laterally spaced side surfaces have pulley-engaging portions. In one form, the rubber composition in the pulley engaging portions is exposed.

The recycled rubber may be devulcanized.

The powdery scrap rubber may be prepared by crushing waste as generated during the formation of power transmission belts.

The invention is further directed to a rubber composition including a fresh rubber, a powdery scrap rubber, and a recycled rubber. The powdery scrap rubber and recycled rubber collectively make up a substantial portion of the rubber composition.

In one form, a combined total amount of the powdery scrap rubber and the recycled rubber is 30 to 110 parts by weight per 100 parts by weight of the fresh rubber.

The weight ratio of the recycled rubber to the powdery scrap rubber may be in the range of 0.4 to 2.5.

The fresh rubber may include chloroprene rubber.

In one form, the powdery scrap rubber has an average primary particle diameter of 30 to 500 μm.

The rubber composition may be incorporated into a belt body of a power transmission belt.

In one form, the belt body has a compression rubber layer and the rubber composition is incorporated into the compression rubber layer.

The power transmission belt may be one of a V-belt and a V-ribbed belt.

### BRIEF DESCRIPTION OF THE DRAWINGS

FIG. 1 is a schematic representation of a power transmission belt having a body with a layer made at least partially from a rubber composition, according to the present invention;

FIG. 2 is a cross-sectional view of a raw edge V-belt incorporating a rubber composition made according to the present invention; and

FIG. 3 is a view as in FIG. 2 of a V-ribbed belt incorporating a rubber composition made according to the present invention.

### DETAILED DESCRIPTION OF THE DRAWINGS

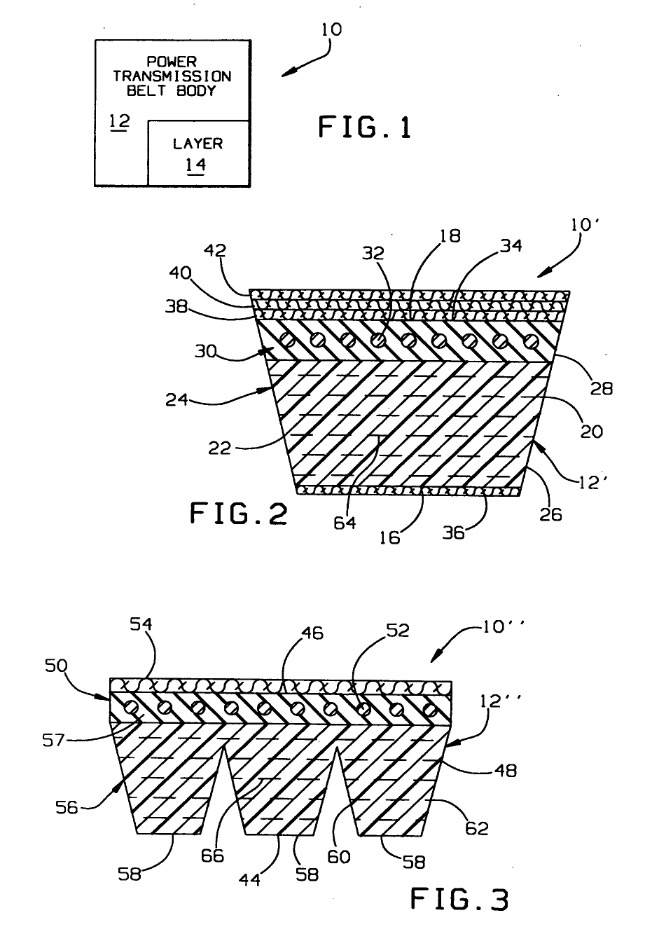

The invention is directed to a rubber composition that utilizes recycled materials. The rubber composition may be used in different environments, and for different purposes. In one preferred form, the rubber composition is used in a power transmission belt, as shown generically at 10 in FIG. 1. The power transmission belt 10 has a body 12 with a layer 14 that is made from the inventive rubber composition, as described in detail below. The power transmission belt 10 may take virtually a limitless number of different shapes and may be made from likewise a virtually limitless number of different combinations of components. More specific, exemplary forms of the power transmission belt depicted in FIG. 1 are shown in FIGS. 2 and 3 at 10′, 10″, respectively, in the form of a V-belt and a V-ribbed belt.

The V-belt 10′ has an endless body 12′, with a length extending into the page, an inside 16 an outside 18, and laterally spaced sides 20, 22. The V-belt 10′ has a compression section 24 consisting of a compression rubber layer 26 and a portion 28 of a cushion rubber layer 30 made from an extensible material. A load carrying member 32, in this embodiment in the form of a spirally wrapped cord, is embedded between the portion 28 and an outer portion 34 of the cushion rubber layer 30. The body 12′ may be constructed with longitudinally spaced cogs (not shown) on the inside 16 and/or outside 18 of the body 12′.

A reinforcing canvas layer 36 is applied on the inside of the body 12′ with a separate reinforcing canvas layer 38 applied on the outside 18 of the body 12′. Optional, additional reinforcing canvas layers 40, 42, are applied successively to the reinforcing canvas layer 38 that is directly applied to the body 12′. This belt construction is characterized as being a “raw edged construction since the rubber composition at pulley-engaging portions of the spaced sides 20, 22 is uncovered/exposed to the cooperating pulleys.

One exemplary method for making the V-belt 10′ will now be described. The components of the power transmission belt 10′ are formed by wrapping the same around a metal mold (not shown). Initially, the canvas layer 36 is wrapped around the metal mold, followed by an unvulcanized rubber sheet that defines the compression rubber layer 26, an unvulcanized rubber sheet defining the cushion rubber layer 30, the load carrying cord 32, and the canvas layers 38, 40, 42. With the above components applied to the metal mold, a sleeve preform results. The sleeve preform is vulcanized under controlled temperature and pressure conditions. The vulcanized sleeve is then acted upon by an appropriate cutter (not shown) to produce individual V-shaped belt preforms having a predetermined width.

The V-ribbed belt 10″ has an elongate body 12″ with an inside 44 and an outside 46. The body 12″ may be formed by serially building components upon a metal mold, as described for the belt 10′. More specifically a compression rubber layer 48, cushion rubber layer 50, load carrying cord 52, and reinforcing canvas layer 54 are serially built up upon the metal mold to produce a sleeve. a portion 57 of the compression rubber layer 48 is part of a compression section 56 within which a plurality, and in this case three, truncated, triangular ribs 58 are formed in laterally spaced relationship. Each rib 58 has laterally spaced sides 60, 62, each to engage a surface on a cooperating, complementarily-formed pulley.

According to the invention, the inventive rubber composition is incorporated into the belts 10, 10′, 10″. The rubber composition contains an unused rubber/fresh rubber ,a powdery scrap rubber, and a recycled rubber that is preferably recovered after a belt sleeve is vulcanized and thereafter formed to produce individual belts. The powdery scrap rubber and recycled rubber are collectively present in an amount to make up a substantial portion of the rubber composition.

The nature of the fresh rubber is not particularly limited. The fresh rubber may be, for example, a chloroprene rubber, hydrogenated nitrile rubber, natural rubber, CSM, ACSM, SBR, or ethylene-α-olefin elastomer.

The powdery scrap rubber is a powder prepared by crushing belt scraps generated during the production of power transmission belts or a powdery dust produced during a grinding process in which a vulcanized sleeve is formed with V-shaped grooves. Preferably, the average primary particle diameter for the powdery scrap rubber is 500 μm or less, and more preferably 30 to 500 μm.

If the average primary particle diameter exceeds 500 μm, a desired reinforcing effect may not be realized, as a result of which the strength and abrasion resistance of the rubber composition may be unacceptably low. Further, cracking may occur at an interface between the fresh rubber and the powdery scrap rubber, as a result of which the belt in which the rubber composition is incorporated may have an unacceptably short, useable life.

The scrap rubber may be recycled in a manner that the scraps generated during power transmission belt formation are converted to powder by freeze crushing, or a like process. In this case, the resulting powdery scrap rubber generally has an average primary particle diameter of 100 to 500 μm.

The powdery scrap rubber may be prepared using a grinding powder/buffing powder generated during the formation of the V-ribbed belts. The buffing powder may be used without change or by practicing sieving. The resultant powdery scrap rubber has an average primary particle diameter of 30-100 μm.

The powdery scrap rubber is preferably added in an amount of 30-70 parts by weight per 100 parts by weight of the fresh rubber. Even if less than 30 parts by weight of the powdery scrap rubber are added, the rubber composition has increased abrasion resistance and good workability.

On the other hand, when more than 70 parts by weight of the powdery scrap rubber are used, the scorching time of the unvulcanized rubber is detrimentally reduced, the viscosity thereof is increased, and the adhesive properties of the rubber sheet are reduced, thereby resulting in poor workability. Further, an interface may be formed between the powdery scrap rubber and the fresh rubber, so that the rubber composition is prone to cracking at this interface, which may detrimentally shorten the belt life.

The recycled rubber is preferably recovered from ring scraps generated during cutting of the vulcanized sleeve to produce the preforms for the V-belt, as described above. The recycled rubber is prepared by devulcanizing scarp rubber pieces with heat, oxygen, regenerant, etc.

The method for recycle the particular ring scraps is not limited. Most commonly, this is accomplished using conventional pan/oil methods. Using this method, vulcanized rubber is crushed into a diameter of 10 mm or less by a multi-purpose crusher having a rotary blade. Dipentine and a reclaimed oil, such as a pine tar, are mixed with the scraps. The mixture is treated with vapor at a pressure of 5 to 15 kgf/cm² for 4-5 hours, to thereby make the vulcanized rubber plastic.

JP-A-9-227724 and JP-A-10-176001 disclose reclaiming methods through which vulcanized rubber is recycled and devulcanized by shearing forces and heat using a single screw extruder.

JP-A-6-287573 discloses a method wherein water, or an aqueous basic solution of 1N or more and a sulfur absorbent, such as metal salt or metal oxide, are added to a crushed, vulcanized rubber. This mixture is subjected to a hydrothermal treatment.

In JP-A-6-287352, a method is disclosed wherein an aqueous basic solution of 1N or more is added to a rubber vulcanized by sulfur or peroxide. The rubber is decomposed in the supercritical region and thus converted to an oil.

In JP-B-2-18696, a vulcanized rubber powder is irradiated with microwaves and heated in the presence of an iron powder.

The invention also contemplates devulcanization, as by ultrasonic, radiation, or other means.

The vulcanized, recycled rubber can be obtained not only from ring scraps, as described above, but also from defectively molded belts that do not meet manufacturing standards. Scraps formed in the longitudinal ends of the vulcanized sleeve and other recycled components are contemplated to be used in the same manner according to the invention.

It is preferred that the canvas layers and cords, etc. be removed from the rubber before recycling is undertaken. This is not a requirement, however.

In the rubber composition, the recycled rubber is recovered from vulcanized rubber that is preferably the same type as the fresh rubber. 30-70 parts by weight of the recycled rubber is added per 100 parts by weight of the fresh rubber.

When the amount of the recycled rubber is more than 70 parts by weight, the physical properties, such as the elasticity modulus for the rubber composition, may be reduced substantially, whereby the belt may exhibit poor abrasion resistance.

The total amount of the powdery scrap rubber and the recycled rubber is collectively preferably 30-110 parts by weight per 100 parts by weight of the fresh rubber. The weight ratio of the recycled rubber to the powdery scrap rubber is preferably 0.4 to 2.5.

When the total amount of the combined powdery scrap rubber and recycled rubber is less than 30 parts by weight, the physical properties of the belt and its useful life may be insignificantly changed. However, the amount of waste recycling that is effected is relatively insignificant, whereby the recycling aims may not be realized.

When the total combined amount of the powdery scrap rubber and recycled rubber is more than 110 parts by weight, the fresh rubber content is low. It is thus difficult to avoid a detrimental change in the physical properties of the belts due to the addition of the recycled rubber. Workability as a result of the addition of the powdery rubber, abrasion resistance, and belt life may be detrimentally affected.

When the weight ratio of the recycled rubber to the powdery scrap rubber is less than 0.4, the recycled rubber may not adequately compensate for the deterioration of workability due to the addition of the powdery scrap rubber.

When the weight ratio is 2.5 or more, the physical properties of the rubber composition may be remarkably reduced due to the addition of the recycled rubber.

When the weight ratio of the recycled rubber to the powdery scrap rubber is 0.4 to 2.5, the disadvantages of each component are compensated for by the positive characteristics of the other to thereby cause a synergistic effect.

Preferably, the inventive rubber composition defines part or all of the compression rubber layer. The rubber composition for the compression rubber layer may additionally include a vulcanizing agent, a vulcanization accelerator, carbon black, an anti-aging agent and/or reinforcing fibers 64, 66, shown respectively in the belts 10′, 10″ in FIGS. 2 and 3, in addition to the fresh rubber, powdery scrap rubber, and recycled rubber.

The vulcanization accelerator is used for increasing the vulcanization degree of the fresh rubber, thereby to prevent the reduction of the physical properties due to the recycled rubber. The vulcanization accelerator is preferably present in an amount of 0.5 to 3 parts by weight per 100 parts by weight of the fresh rubber. However, this quantity is not a requirement.

Examples of suitable vulcanization accelerators include N,N′-m-phenylenedimaleimide, ethylene thiourea, diethylthiourea, trimethylthiourea, tetramethylthiuram monosulfide, tetramethylthiuram disulfide, and dibenzothiazyl disulfide, and most preferred among tthose hem is N,N′-m-phenylenedimaleimide.

The carbon black may be SAF, ISAF, HAF, FEF, GPF, SRF, etc. SAF, ISAF, and HAF, have excellent abrasion resistance and are preferred among this group, particularly with a raw edge V-belt. However, carbon black with excellent abrasion resistance has a small average primary particle diameter. As a result, heat generation inside the rubber may be detrimentally increased, potentially resulting in rapid deterioration of the rubber. Thus, FEF, GPF, etc. with an appropriately large average primary particle diameter are preferably used.

The amount of carbon black is preferably 40 parts by weight or less per 100 parts by weight of the fresh rubber.

When the amount is more than 40 parts by weight, the properties of the rubber maybe out of balance, and particularly the tear strength may be detrimentally reduced.

The method of mixing the above components into the basic rubber composition, including the fresh rubber, powdery scrap rubber, and recycled rubber, is not particularly limited. Mixing may be carried out using a Banbury mixer, roller, or kneader. The recycled rubber may be added and mixed in the same manner as the above components,.

It has been found that in the event only the powdery scrap rubber, in less than 30 parts by weight, is added, the resultant composition has an increased abrasion resistance and good workability. However, when more than 50 parts by weight of the powdery scrap rubber is added, the scorching time of the unvulcanized rubber is reduced, the viscosity thereof is increased, and the adhesion properties of the rubber sheet are reduced, potentially resulting in poor workability. Further, an interface is often formed between the powdery scrap rubber and the fresh rubber, so that the rubber composition is prone to cracking at the interface, which may detrimentally shorten the belt life.

In the case of adding only the recycled rubber, when less than 30 parts by weight is added, the physical properties, such as the elasticity modulus with the resulting composition are reduced only slightly, and the life of the belt is increased. However, when more than 50 parts by weight of the recycled rubber is added, the elasticity modulus is significantly reduced, as are abrasion resistance and the belt life.

The elasticity modulus can be increased by reinforcement, as by using carbon black, etc. However, when the amount of filler is increased, the fresh rubber content is increased and the ratio of the recycled rubber to the fresh rubber is reduced, thereby resulting in use of less than the desired amount of recycled materials.

By using the scrap rubber and recycled rubber in combination, the recycled rubber can prevent the increase in viscosity of the unvulcanized rubber and the decrease in the adhesion of the rubber sheet due to the powdery scrap rubber. The powdery scrap rubber can prevent the decrease in the abrasion resistance due to the recycled rubber. Thus, more than 50 parts of the rubber can be added to the rubber composition according to the invention, though it is difficult to add a large amount of only one of the recycled rubber and powdery scrap. A large amount of the waste generated in belt production can thus be used and recycled according to the invention.

A power transmission belt with satisfactory abrasion resistance and durability can be made according to the present invention using a significant amount of recycled material, including powdery scrap rubber prepared by crushing rubber waste and recycled rubber recovered from waste. Consequently, material costs can be reduced, as can the amount of waste delivered to land fills or otherwise disposed of that might have a detrimental environmental effect. The power transmission belts can be made at a reduced cost while maintaining desired properties thereof.

The operating characteristics of belts made using the inventive rubber composition will now be described in comparison to conventional-type belts.

Inventive Examples 1-3, Comparative Examples 1-5 and Reference Example 1 were prepared as follows. A powdery scrap rubber and a recycled rubber were added to 100 parts by weight of chloroprene rubber and kneaded using an internal mixer. The Mooney viscosity of the kneaded rubber was measured according to JIS K6300-1. The kneaded rubber was formed into a sheet with a predetermined thickness by a calender roller and vulcanized at 153° C. for 20 minutes. The hardness (JIS-A), elongation at breaking EB, and stress at 100% elongation M100 of the vulcanized rubber were measured respectively according to JIS K6253, JIS K6251, and JIS K6251. The resulting rubber sheet was used in the compression rubber layer to produce a raw edged V-belt with a circumference of 1,055 mm. The wear rate was evaluated by a 6% slip driving test, with the durability evaluated by a high temperature endurance test. Workability was evaluated by the surface state and adhesive properties of the unvulcanized rubber sheet, and the belt molding workability. The results of the evaluation are shown in Table 1, below, wherein the compositions of each of the Inventive, Comparative, and Reference Examples are set out.

TABLE 1
(parts by weight)

| | Comparative | | | | | | Comparative | | | Reference |
|---|---|---|---|---|---|---|---|---|---|---|
| | Example | | Inventive Example | | | | Example | | | Example |
| | 1 | 2 | 1 | 2 | 3 | 4 | 3 | 4 | 5 | 1 |
| Chloroprene | 100 | 100 | 100 | 100 | 100 | 100 | 100 | 100 | 100 | 100 |
| rubber | | | | | | | | | | |
| Reinforcing short fiber | 10 | 10 | 10 | 10 | 10 | 10 | 10 | 10 | 10 | 10 |
| Magnesium oxide | 5 | 5 | 5 | 5 | 5 | 5 | 5 | 5 | 5 | 5 |
| Carbon black N550 | 40 | 40 | 40 | 40 | 40 | 40 | 40 | 40 | 40 | 40 |
| Powdery rubber | 60 | 60 | 60 | 30 | 30 | 70 | 60x | 10x | —x | — |
| Recycled rubber | —x | 10x | 30 | 30 | 60 | 40 | 60x | 60 | 60 | — |
| Aromatic oil | 5 | 5 | 5 | 5 | 5 | 5 | 5 | 5 | 5 | 5 |
| Sulfur | 1 | 1 | 1 | 1 | 1 | 1 | 1 | 1 | 1 | 1 |
| Stearic acid | 0.5 | 0.5 | 0.5 | 0.5 | 0.5 | 0.5 | 0.5 | 0.5 | 0.5 | 0.5 |
| Zinc oxide | 5 | 5 | 5 | 5 | 5 | 5 | 5 | 5 | 5 | 5 |

Physical properties of rubber

| | | | | | | | | | | |
|---|---|---|---|---|---|---|---|---|---|---|
| Mooney viscosity (at 100° C.) | 105x | 97x | 85 | 64 | 55 | 80 | 65 | 46 | 40 | 50 |
| M100 (MPa) | 6.1 | 5.7 | 5.3 | 5.1 | 47 | 5.1 | 4.4 | 4.2 | 4.0 | 5.0 |
| EB (%) | 200 | 218 | 240 | 265 | 270 | 250 | 260 | 280 | 285 | 265 |

Belt driving test

| | | | | | | | | | | |
|---|---|---|---|---|---|---|---|---|---|---|
| 6% slip wear rate (%) | 2.0 | 2.1 | 2.4 | 2.7 | 2.9 | 2.7 | 3.5 | 4.1x | 4.3x | 2.7 |
| Life under high temperature driving (hr) | 48x | 48x | 72 | 80 | 80 | 80 | 56x | 90 | 90 | 72 |
| Workability | Bad x | Rather | Good | Good | Good | Good | Good | Good | Good | Good |
| | | Bad x | | | | | | | | |

In the 6% slip driving test, the raw edged V-belt was trained around driving and driven pulleys, each having a 65 mm diameter, and a tension pulley having a 120 mm diameter. The belts were operated in a tester at room temperature for 24 hours while controlling tension so that the torque of the driven pulley was 9.8 N·m. The weight of the belt was measured before and after the test, and the wear rate of the belt was calculated from the weight reduction.

In a high temperature endurance test, the raw edged V-belt was trained at an initial tension of 85 kgf around driving and driven pulleys each with a diameter of 125 mm, and a tension pulley having a diameter of 70 mm. The belts were placed in a tester and driven at 85° C. at 4700 rpm.

In evaluation of workability, “good” means that the rubber had excellent surface state and adhesion properties. “Rather bad” means that the rubber sheet had low adhesion. “Bad” means that the rubber sheet had a bad surface condition and low adhesion properties.

In Comparative Example 1, the unvulcanized rubber had a high viscosity. The rubber sheet was poor in terms of adhesion and the surface state. There was also a problem with workability.

With Comparative Example 2, the adhesive properties and the surface state of the sheet were not good but slightly improved.

With Comparative Example 3, the workability was adequate. However, the physical properties of the rubber were compromised, and cracking was generated rapidly in the belt during the endurance test, as a result of which the belt life was substantially shortened.

In Comparative Examples 4 and 5, the physical properties of each rubber were significantly reduced due to the addition of the recycled rubber. The abrasion resistant was remarkably reduced, though the belt had an adequate life.

With the inventive structure, a potentially relatively low cost, abrasion resistance, flexible, power transmission belt can be made from a rubber composition using recycled materials, such as those generated during belt production.

The foregoing disclosure of specific embodiments is intended to be illustrative of the broad concepts comprehended by the invention.

1. A power transmission belt comprising:
an endless body having a length, an inside, an outside, and laterally spaced sides,
at least a part of the belt body made from a rubber composition comprising:
a fresh rubber;
a powdery scrap rubber; and
a recycled rubber,
wherein the powdery scrap rubber and recycled rubber collectively make up a substantial portion of the rubber composition.

2. The power transmission belt according to claim 1 wherein a combined total amount of the powdery scrap rubber and the recycled rubber is 30 to 110 parts by weight per 100 parts by weight of the fresh rubber.

3. The power transmission belt according to claim 1 wherein the weight ratio of the recycled rubber to the powdery scrap rubber is 0.4 to 2.5.

4. The power transmission belt according to claim 2 wherein the weight ratio of the recycled rubber to the powdery scrap rubber is 0.4 to 2.5.

5. The power transmission belt according to claim 1 wherein the fresh rubber comprises chloroprene rubber.

6. The power transmission belt according to claim 4 wherein the fresh rubber comprises chloroprene rubber.

7. The power transmission belt according to claim 1 wherein the powdery scrap rubber has an average primary particle diameter of 30 to 500 μm.

8. The power transmission belt according to claim 4 wherein the powdery scrap rubber has an average primary particle diameter of 30 to 500 μm.

9. The power transmission belt according to claim 5 wherein the powdery scrap rubber has an average primary particle diameter of 30 to 500 μm.

10. The power transmission belt according to claim 1 wherein the belt body comprises a compression rubber layer and the compression rubber layer comprises the rubber composition.

11. The power transmission belt according to claim 10 wherein the belt body comprises at least one load carrying member extending in a lengthwise direction.

12. The power transmission belt according to claim 1 wherein the power transmission belt is one of a V-belt and a V-ribbed belt.

13. The power transmission belt according to claim 1 wherein there is at least one canvas layer on at least one of the inside and outside of the belt body.

14. The power transmission belt according to claim 13 wherein the laterally spaced side surfaces have pulley-engaging portions at which the rubber composition is exposed.

15. The power transmission belt according to claim 1 wherein the recycled rubber is devulcanized.

16. The power transmission belt according to claim 15 wherein the powdery scrap rubber is prepared by crushing waste as generated during the formation of power transmission belts.

17. A rubber composition comprising:
a fresh rubber;
a powdery scrap rubber; and
a recycled rubber,
wherein the powdery scrap rubber and recycled rubber collectively make up a substantial portion of the rubber composition.

18. The rubber composition according to claim 17 wherein a combined total amount of the powdery scrap rubber and the recycled rubber is 30 to 110 parts by weight per 100 parts by weight of the fresh rubber.

19. The rubber composition according to claim 17 wherein the weight ratio of the recycled rubber to the powdery scrap rubber is 0.4 to 2.5.

20. The rubber composition according to claim 18 wherein the weight ratio of the recycled rubber to the powdery scrap rubber is 0.4 to 2.5.

21. The rubber composition according to claim 17 wherein the fresh rubber comprises chloroprene rubber.

22. The rubber composition according to claim 18 wherein the powdery scrap rubber has an average primary particle diameter of 30 to 500 μm.

23. The rubber composition according to claim 17 wherein the rubber composition is incorporated into a belt body of a power transmission belt.

24. The rubber composition according to claim 23 wherein the belt body comprises a compression rubber layer and the rubber composition is incorporated into the compression rubber layer.

25. The rubber composition according to claim 24 wherein the power transmission belt is one of a V-belt and a V-ribbed belt.
